(19) United States
(12) Patent Application Publication
(10) Pub. No.: US 2008/0103657 A1
(43) Pub. Date: May 1, 2008

(54) System and method for tracking information related to a vehicle

(76) Inventors: Merritt Norton, Preston, WA (US); John Norton, Lehi, UT (US); Merritt Ronald Norton, Provo, UT (US)

Correspondence Address: Merritt Norton, 7509 308th Ave., SE, P.O. Box 553, Preston, WA, 98050, US

(21) Appl. No.: 11/973,352

(22) Filed: Oct. 5, 2007

Related U.S. Application Data
(60) Provisional application No. 60/849,707, filed on Oct. 5, 2006.
(60) Provisional application No. 60/906,868, filed on Mar. 15, 2007.

(51) Int. Cl. G06F 19/00; G06Q 30/00

(52) U.S. Cl. 701/35; 705/30

(57) ABSTRACT

A method and system for delivering information regarding a vehicle, comprising: accepting user input information on a touch screen from a user as soon as ignition of vehicle is turned on and/or off; based on the user input information, track information related to the vehicle; and uploading the information related to the vehicle to a central server for analysis.

This application claims priority to provisional application 60/849,707, filed Oct. 5, 2006, and entitled “System and Method for Expense and Mileage Tracking of a Self-Contained Onboard Computer System with Primary Function of Tracking Vehicle Mileage and Expenses”. The application also claims priority to provisional application 60/906,858, filed Mar. 15, 2007, and entitled “Method of Delivering In-Vehicle Advertising and Information and Vehicle Specific Carbon Emissions Tracking”.

### DETAILED DESCRIPTION OF EMBODIMENTS OF THE INVENTION

In one embodiment, a self contained onboard computer system is provided with a primary function of tracking vehicle mileage and expenses such as gas, oil changes, etc. Other functions may include navigation, viewing of suggested specific vehicle maintenance schedules and reminders when service is due, computation of real-time vehicle operating costs, on-demand coupons for local businesses, speed warning, and vehicle auditing. In one embodiment, the system can communicate with an external network using wireless technology. The system can communicate with the user/operator using screen prompt and/or speech technology. Data collected can be stored in removable non-volatile memory. This can allow the user to transport the data to a personal computer where the data can be further analyzed. Other options for data transfer include the use of wireless options such as local wireless networks (hot spots) or wide area networks (WAN) to transfer the data to a web site where the data can be stored and analyzed. Other functionally may include transmitting real-time anonymous location and speed information to a centralized server via a WAN link to be used for real-time traffic conditions and predictions. Further, the device may transmit such data to a secure server where the owner of the vehicle may login to pinpoint the location of his vehicle.

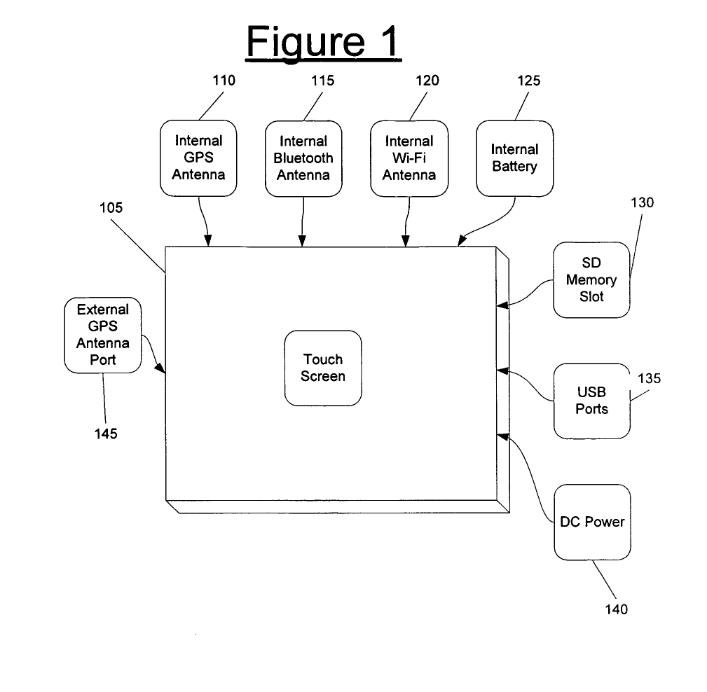

FIG. 1 illustrates various components of the screen display. 105 illustrates the plastic housing for the touch screen 105. Internal GPS antenna 110 receives signals from GPS satellites. Internal blue tooth antenna 115 facilitates Blue tooth communications between this device and any other blue tooth device. Internal Wi-Fi antenna enables network communications using Wi-Fi technology. Internal battery 125 supplies power to the unit in case hardware power is not available. Memory card slots 130 is an SD memory slot for memory expansion and data storage. USB ports 135 are used to connect the device to a personal computer for updates and other input peripherals. Power port 140 is used to obtain DC power via a hardware connection to the vehicle or through the DC power slot on the vehicle. External GPS antenna connection 145 provides another external (outside the interior of the vehicle) connection to the GPS system.

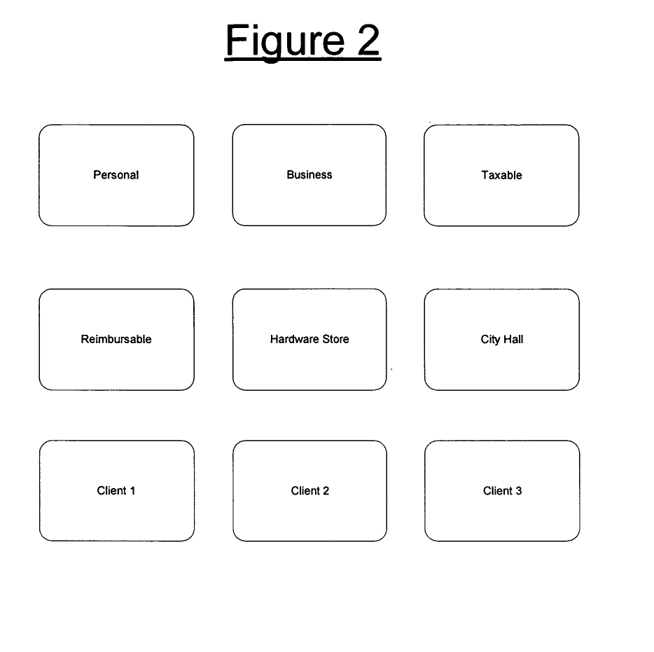

FIG. 2 illustrates various categories that can be used to tag trip data.

Global Positioning System (GPS) Technology

The ability for the system to perform mileage tracking, navigation, and location pinpointing can rely on the use of Global Positioning System (GPS) technology. This allows the system to be completely portable and does not require any special equipment to be installed on the vehicle. Those of ordinary skill in the art will see that other types of technology can be used to perform mileage tracking, navigation and location tracking respectively.

Method to Input Device

The ability to input information into the system can be made available using touch-screen technology. Input devices can include a portable wireless keyboard and voice recognition.

Vehicle Mileage

One function of the device is to track and classify mileage for IRS, business, charitable or any other purpose. When the vehicle is started, the device can automatically power on and prompt the user to classify the upcoming trip. The user can have the ability to customize the option in any number of ways including sub categories. An example might include choosing a primary category of “Business” and a sub category of “Client: ABC”. Customization of this device can take place using the built-in interface and include input devices, or the device can be connected to a personal computer and use specialized software. Recording of the beginning date and time of the trip can automatically happen using a built in clock. The clock can be set manually or can automatically sync time based on the GPS satellites atomic clock.

In the event that the vehicle begins to move without a category being selected, the device can warn the operator using visual and/or voice prompts. In the event that a category is not selected, the device can automatically record the trip as an un-classified trip. The user can have the ability to classify the trip at any time.

The user can signal a termination of the trip at any time by using the supplied input devices (touch screen) etc, when power is cut off from the device, or when the vehicle has not moved for a predetermined amount of time.

Analyzing the data can take place using a custom developed internet web site. Data can be sent to the website in several methods, including but not limited to:
1. The operator can remove the memory from the device and upload the data to the website using a personal computer with an internet connection.
2. If the device is in range of a local wireless network, the user can instruct the device to connect to the internet via the network and upload the data.
3. If the user has access to a wide area network, this method can be used to transmit the data.
   Vehicle Expense and Real-Time Operating Costs

Using the supplied input devices, the operator has the ability to track vehicle expenses such as fuel, oil changes, etc. For example when an operator puts fuel in the vehicle, he can input the number of gallons and price of gas. The system, using historical data (Fuel, Oil Changes, Tires, etc) can calculate and display to the operator information such as, miles per gallon (MPG) for the last tank of gas, average MPG for a certain time period (e.g., the last 30 days), cost per mile (CPM) for the last take of gas, average CPM for a certain time period (e.g., the last 30 days), etc.

Vehicle Maintenance Schedules

Upon purchasing the device the consumer or business can download a detailed schedule of maintenance for the specific vehicle. The onboard computer can track vehicle usage and mileage through GPS and prompt the user when service or maintenance is needed based on the detailed schedule. Synchronization of the vehicle odometer with the device can be required for this functionality. Information about upcoming maintenance may optionally be transmitted to local business/dealerships where they might send out a coupon to the operator to be used for the upcoming maintenance.

Navigation

Navigation can be offered.

Speed Warning

When the vehicle is traveling on a road and exceeds the posted speed limit, the device can warn the user using visual and/or voice prompts. Other prompts may include “School Crossing Ahead”, “Rail Road Crossing Ahead”, “Dangerous Curve Ahead” etc.

Data for this function may have to be collected and compiled. The ability to extrapolate the data based on road type may also be done, in one embodiment.

Network Communications

The device can be equipped to communicate with a local wireless network or a wide area wireless network (WAN). When the device is in range of the local wireless network such as at the operator's home, the device can automatically connect to the internet and upload the mileage data to a secure web site. An example of using a WAN would be as the vehicle is moving, data about speed, and location can be sent in real time to someone specifically tracking the vehicle, or it can be sent anonymously to an agency that is computing real time delays and then using such data to predict future delays.

Vehicle Auditing

The device can have enough memory to be able to store data beyond beginning and ending mileage. Actual route driven, speed, etc. can be stored in memory and software call have the ability to analyze the data.

Supply of Power

The device can be connected directly to the battery of the car or use the DC power outlet. In order to keep the device connected to GPS satellite signals, the device can go into a power conservation mode. This can keep the operator from having to wait for readings from the satellites. In the event that power is completely cut off from the device, a battery backup can perform his function. Hardwiring the device to the car can enable the device to detect the starting of the ignition thus prompting the operator to choose a mileage category.

In-Vehicle Proximity Advertising

In another embodiment, the system has the ability to receive advertising and information based on vehicle location. This data transmission would utilize local or wide-area WiFi, WiMax, cellular or other capability that can allow the onboard computer system to receive advertisements and/or other information from sources outside the vehicle (Centrally located data center servers or close range data servers), either through real-time communication or through messages that are downloaded periodically based on past historical travel patterns and current direction of travel.

In one embodiment, the system can upload travel pattern information that could then trigger email advertising based on travel patterns as coupled with preset “user interest categories.” This data and information could be sent to the on-board device or the owner's email or other advertising and communications media in real-time or whenever the system comes in contact with a wide-area network or suitable communications medium.

### EXAMPLE EMBODIMENTS

As the vehicle is moving, it is sending vehicle location information to a central server. Once the vehicle enters a pre-defined zone, the server sends an advertisement to the vehicle computer. A computer server identifies that the vehicle's direction of travel is within one-half mile of a gas station that has the lowest gas price within a 10-mile radius. The server is also aware, through communication with the onboard computer system, that the vehicle has a quarter tank of gas. The server then sends a message to the vehicle about the cost of fuel at the upcoming station and recommends a fill up.

In another example, a business could sign up and pay a fee to have an advertising coupon sent to all vehicles with the system that are traveling within a specific area near the business and/or during a specific time and/or other parameters agreed to by the vehicle operator and server operator.

In another embodiment, the vehicle is moving and storing travel history based on GPS or other methods for determining vehicle location. This data is stored in the on-board computer system. When the vehicle comes within communications range of a WiFi or other free or low cost communications connection, it uploads recent travel history and current direction of travel to a communications server in a remote data center. For example, if the travel history indicates that the vehicle is used to follow the same route (e.g., to work and then to school to pick up children), this history would be downloaded. The server can then download advertising and other driver information to the vehicle; this information would be based on that particular vehicle's historical travel routes, time of day, area of travel and/or the driver's pre-selected user interest categories. For example, the server could indicate where on the Thursday route the driver could buy the cheapest gas. This communication could take place once a day when the vehicle returns home or more often depending on communications availability.

The on-board device could also communicate directly peer to peer with businesses or information servers that are within wireless range without using an intermediate communications source such as WIFI. The two-way communications capability would also allow for software updates and downloads and other useful two-way data transfer.

Vehicle Carbon Emissions Tracking

Another function of the onboard computer system (device) could be tracking the “carbon footprint” or CO₂ emissions of the specific vehicle based on actual fuel burn data obtained by the system from the engine control module, or the system can calculate carbon or other emissions based on published engine emissions data together with fuel purchased, distance traveled and miles per gallon data analyzed using a mathematical programming algorithm. Lastly carbon emissions can be tracked based on sensors placed in the exhaust stream that would communicate this data to the on-board computer system.

The on-board computer system could then report historical carbon emissions data based on the last trip, the last week, month, year, vehicle life or any other valuable data point. This information could be uploaded to a secure server for review and or auditing functions for a vehicle fleet status and or voluntary or mandatory reduction verification. This data could be paired with GPS location data to determine locations of greatest emissions for the specific vehicle.

This data is useful for carbon credit trading and offset mitigation strategies to reduce greenhouse gas emissions and other harmful pollutants.

### CONCLUSION

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments. As another example, more than two data sets could be used in each analysis.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

### PRIOR ART

U.S. Pat. No. 6,615,186
U.S. Pat. No. 6,347,216
U.S. Pat. No. 6,856,820
U.S. Pat. No. 7,003,289
U.S. Pat. No. 6,389,337
U.S. Pat. No. 7,092,724
U.S. Pat. No. 7,016,854
U.S. Pat. No. 6,640,098
U.S. Pat. No. 7,071,842
U.S. Pat. No. 6,957,133
U.S. Pat. No. 6,738,697
U.S. Pat. No. 4,875,167
U.S. Pat. No. 5,579,242
U.S. Pat. No. 5,787,373
U.S. Pat. No. 5,893,893
U.S. Pat. No. 6,064,929
U.S. Pat. No. 6,718,263
U.S. Pat. No. 6,741,933
U.S. Pat. No. 6,778,900

1. A method for delivering information regarding a vehicle, comprising:
accepting user input information on a touch screen from a user as soon as the ignition of the vehicle is turned on and/or off,
based on the user input information, track information related to the vehicle; and
uploading the information related to the vehicle to a central server for analysis.

2. The method of claim 1, wherein GPS technology is used to track the information related to the vehicle.

3. The method of claim 1, further comprising using non-volatile RAM to store the information related to the vehicle.

4. The method of claim 1, wherein a wi-fi wireless connection is utilized to upload the information related to the vehicle to the central server.

5. The method of claim 1, further comprising downloading analyzed information related to the vehicle to the touch screen from the central server.

6. The method of claim 1, wherein information related to the vehicle is sent to the server in a peer-to-peer manner using short range communication.

7. The method of claim 1, wherein the information related to the vehicle comprises:
information related to vehicle mileage;
information related to vehicle expense and/or real-time operating costs;
information related to vehicle maintenance;
information related to vehicle speed;
information related to vehicle auditing;
information related to vehicle power;
information related to carbon emissions; or
information related to past travel history and advertising, or
any combination thereof.

8. The method of claim 1, wherein:
an electrical system of the vehicle; or
ODB2 port; or
any combination thereof.
